(19) United States
(12) Patent Application Publication
(10) Pub. No.: US 2010/0087325 A1
(43) Pub. Date: Apr. 8, 2010

(54) BIOLOGICAL SAMPLE TEMPERATURE CONTROL SYSTEM AND METHOD

(75) Inventor: Dale Buermann, Los Altos, CA (US)

Correspondence Address: Patrick S. Yoder;FLETCHER YODER, P.O. Box 692289, Houston, TX, 77269-2289, US

(73) Assignee: Illumina, Inc., San Diego, CA (US)

(21) Appl. No.: 12/565,606

(22) Filed: Sep. 23, 2009

Related U.S. Application Data
(60) Provisional application No. 61/103,411, filed on Oct. 7, 2008.

(51) Int. Cl. C40B 30/00; C40B 60/12

(52) U.S. Cl. 506/7; 506/39

(57) ABSTRACT

The present invention provides a novel approach for controlling the temperature of biological samples on a support structure. The support structure may, for instance, be a flow cell through which a reagent fluid is allowed to flow and interact with biological samples. A thermoelectric heat exchange device, such as a Peltier device, may be used to heat or cool the biological samples on the support structure. In addition, a fluid circulating heat exchange device, such as a water heating or cooling system, may be used to heat or cool the thermoelectric heat exchange device. In general, the support structure may be located on top of the thermoelectric heat exchange device which, in turn, may be located on top of the fluid circulating heat exchange device. The thermoelectric heat exchange device and fluid circulating heat exchange device may be integrated into a holder bench which may be part of a station within an imaging processing system. The holder bench may be configured to hold multiple support structures at a time. In addition, the support structures may be configured to be evaluated and imaged using both epifluorescent and total internal reflection (TIRF) excitation techniques.

### CROSS REFERENCE TO RELATED APPLICATIONS

This application is a Non-Provisional of U.S. Provisional Patent Application No. 61/103,411, entitled “Biological Sample Temperature Control System and Method,” filed Oct. 7, 2008, which is herein incorporated by reference.

### BACKGROUND

The present invention relates generally to the field of evaluating and imaging biological samples. More particularly, the invention relates to a technique for controlling the temperature of biological samples on a support structure.

There are an increasing number of applications for imaging of biological samples on a support structure. For instance, these support structures may include deoxyribonucleic acid (DNA) and ribonucleic acid (RNA) probes that are specific for nucleotide sequences present in genes in humans and other organisms. Individual DNA or RNA probes may be attached at specific locations in a small geometric grid or array on the support structure. Depending upon the technology employed, the samples may attach at random, semi-random, or predetermined locations on the support structure. A test sample, such as from a known person or organism, may be exposed to the array or grid, such that complimentary genes or fragments may hybridize to probes at the individual sites on the support structure. In certain applications, such as sequencing, templates or fragments of genetic material may be located at the sites, and nucleotides or other molecules may be caused to hybridize to the templates to determine the nature or sequence of the templates. The sites may then be examined by scanning specific frequencies of light over the sites to identify which genes or fragments in the sample were present, by fluorescence of the sites at which genes or fragments hybridized.

In order to facilitate the interaction between the samples and complimentary probes, the temperature of the support structure, the samples, and/or the complimentary probes may be increased or decreased, depending on the specific application. However, as these temperatures change, the physical properties of the surrounding structures, such as the support structure, may also change. This may prove problematic if the temperature changes become too great in that the physical structures may become susceptible to contraction, expansion, and other forms of distortion. If any of these types of distortion become too great, the evaluation and imaging of the sites may be compromised in that the sites may either not remain in the same location or may otherwise change orientation between successive steps in the process. Furthermore, unwanted temperature changes in reagents can have adverse effects on chemical reactions or binding events that are relied upon for detection of biological samples. This may lead to lower overall quality and reliability of the genetic sequencing being performed.

### BRIEF DESCRIPTION

The present invention provides a novel approach for controlling the temperature of biological samples, for example, on a support structure. In embodiments wherein the support structure is present in a detection system, the approach for controlling sample temperature can further provide control of the temperature of the detection system, in particular the region of the detection system where the support structure or biological sample resides. Accordingly, the invention provides a detection system having a first heat exchange device and a second heat exchange device. The first heat exchange device may be disposed in direct thermal contact with the support structure or biological sample, the first heat exchange device thereby being capable of removing heat from the sample or heating the sample. The first heat exchange device may produce a thermal load on the detection system, for example, in the region of the detection system where the support structure or biological sample resides.

The second heat exchange device may be disposed in thermal contact with the first cooling device, the second cooling device being configured to displace or exhaust the thermal load generated by the first cooling device. Typically, the first heat exchange device may provide a relatively rapid thermal response and/or relatively fine tuned thermal response at the expense of producing a thermal load on the surrounding environment, whereas the second heat exchange device may provide relatively slower thermal response and/or coarser tuned thermal response (compared to the first heat exchange device) albeit with the advantage of displacing the location where heat is produced and/or exhausted.

The support structure may, for instance, be a flow cell through which a reagent fluid is allowed to flow and interact with biological samples. A thermoelectric heat exchange device, such as a Peltier device, may be used to heat or cool the biological samples on the support structure. In addition, a fluid circulating heat exchange device, such as a water cooling or heating system, may be used to heat or cool the thermoelectric heat exchange device. In general, the support structure may be located on top of the thermoelectric heat exchange device which, in turn, may be located on top of the fluid circulating heat exchange device. The thermoelectric heat exchange device and fluid circulating heat exchange device may be integrated into a holder bench which may be part of a station within an imaging processing system. The holder bench may be configured to hold multiple support structures at a time. In addition, the support structures may be configured to be evaluated and imaged using both epifluorescent and total internal reflection (TIR) excitation techniques.

Accordingly, the invention provides a system for analyzing biological samples. The system includes a support for a biological sample. The system also includes a thermoelectric heat exchange device disposed adjacent to the support and configured to introduce heat into or extract heat from the biological sample. The system further includes a fluid circulating heat exchange device disposed adjacent to the thermoelectric heat exchange device and configured to introduce heat into or extract heat from the thermoelectric heat exchange device.

The invention further provides a system for analyzing biological samples which includes a station configured to receive a biological sample support. The station includes a thermoelectric cooling device disposed adjacent to the support and configured to extract heat from the biological sample. The station further includes a fluid circulating cooling device disposed adjacent to the thermoelectric cooling device and configured to extract heat from the thermoelectric cooling device. Alternatively or additionally, the station may further include a fluid circulating heating device disposed adjacent to the thermoelectric cooling device and configured to introduce heat to the thermoelectric cooling device.

The invention also provides a system for analyzing biological samples which includes a station configured to receive a biological sample support. The station includes a thermoelectric heating device disposed adjacent to the support and configured to introduce heat into the biological sample. The station further includes a fluid circulating heating device disposed adjacent to the thermoelectric heating device and configured to introduce heat into the thermoelectric heating device. Alternatively or additionally, the station may include a fluid circulating cooling device disposed adjacent to the thermoelectric cooling device and configured to extract heat from the thermoelectric cooling device.

In addition, the invention provides a method for analyzing biological samples. The method includes disposing a biological sample adjacent to a support. The method also includes cooling or heating the biological sample, for example, via a thermoelectric heat exchange device disposed adjacent to the support. The method further includes cooling or heating the thermoelectric heat exchange device, for example, via a fluid circulating heat exchange device disposed adjacent to the thermoelectric heat exchange device.

Further, the invention provides a system for analyzing biological samples. The system includes a support for a biological sample. The system also includes a thermoelectric heat exchange device disposed adjacent to the support and configured to introduce heat into or extract heat from the biological sample. The system further includes a fluid circulating heat exchange device disposed adjacent to the thermoelectric heat exchange device. In addition, the system includes a subplate disposed adjacent to the fluid circulating heat exchange device. In particular embodiments, the fluid circulating heat exchange device is configured to maintain the temperature of the subplate at a substantially constant temperature. In other embodiments, the fluid circulating heat exchange device may be configured to raise or lower the temperature of the subplate or biological sample by a desired amount to achieve a desired temperature for a desired time period.

The invention is described herein by reference to a thermoelectric device that heats or cools a biological sample and a fluid circulating device that heats or cools the thermoelectric device. An advantage of this configuration is that heat generated by a thermoelectric device at a point of sample detection may be removed from the detection area by the circulating fluid. The circulating fluid may, in turn, be cooled by a refrigeration unit that is maintained at a location that is remote from the sample detection area, such that heat generated by the refrigeration unit has little to no effect on the ambient temperature of the sample detection area. The invention is not, however, limited by the advantages of the aforementioned embodiment. In this regard, it will be understood that the thermoelectric device and fluid circulating device may be used interchangeably. Moreover, any of a variety of heating and/or cooling devices known in the art may be substituted for the devices described herein in order to achieve the functions described herein.

### DRAWINGS

FIG. 1 is a diagrammatical overview for a biological sample imaging system in accordance with the present invention;

FIG. 2 is a diagrammatical overview of a biological sample processing system which may employ a biological sample imaging system of the type discussed with reference to FIG. 1;

FIG. 3 is a sectional side view of an exemplary support structure, temperature control element, subplate, and translation system using temperature control techniques in accordance with the present invention;

FIG. 4 is a top view of an exemplary support structure and temperature control element using temperature control techniques in accordance with the present invention;

FIG. 5 is a top view of an exemplary support structure configured for use with the temperature control techniques in accordance with the present invention;

FIG. 6 is a top view of an exemplary subplate using temperature control techniques in accordance with the present invention;

FIG. 7 is another sectional side view of an exemplary support structure, temperature control element, and subplate using temperature control techniques in accordance with the present invention;

FIGS. 8A and 8B are charts of exemplary temperature changes of the temperature control element and subplate over time in accordance with the present invention;

FIG. 9 is an isometric view of an exemplary embodiment of a holder bench incorporating the support structure, temperature control element, and subplate and using the temperature control techniques of the present invention;

FIGS. 10A and 10B are a top and side view of an exemplary embodiment of a support structure including vacuum channels along its periphery;

FIG. 11 is an isometric view of a more detailed exemplary embodiment of a holder bench incorporating the support structure, temperature control element, and subplate and using the temperature control techniques of the present invention;

FIG. 12 is an isometric view of another exemplary embodiment of a holder bench incorporating support structures, temperature control element, and subplate and using the temperature control techniques of the present invention;

FIG. 13 is an isometric view of another exemplary embodiment of the holder bench illustrated in FIG. 12;

FIG. 14 is an isometric view of an exemplary embodiment of the subplate layer of the holder bench illustrated in FIG. 12;

FIG. 15 is a top view of an exemplary embodiment of the holder bench incorporating multiple support structures and using the temperature control techniques of the present invention;

FIG. 16 is a sectional side view of an exemplary embodiment of the holder bench incorporating multiple support structures and using the temperature control techniques of the present invention;

FIG. 17 is an isometric view of an exemplary embodiment of the support structure and the prism using the TIRF-related imaging techniques of the present invention; and

FIGS. 18A and 18B are sectional side views of an exemplary embodiment of the support structure and the prism using the TIRF-related imaging techniques of the present invention.

### DETAILED DESCRIPTION

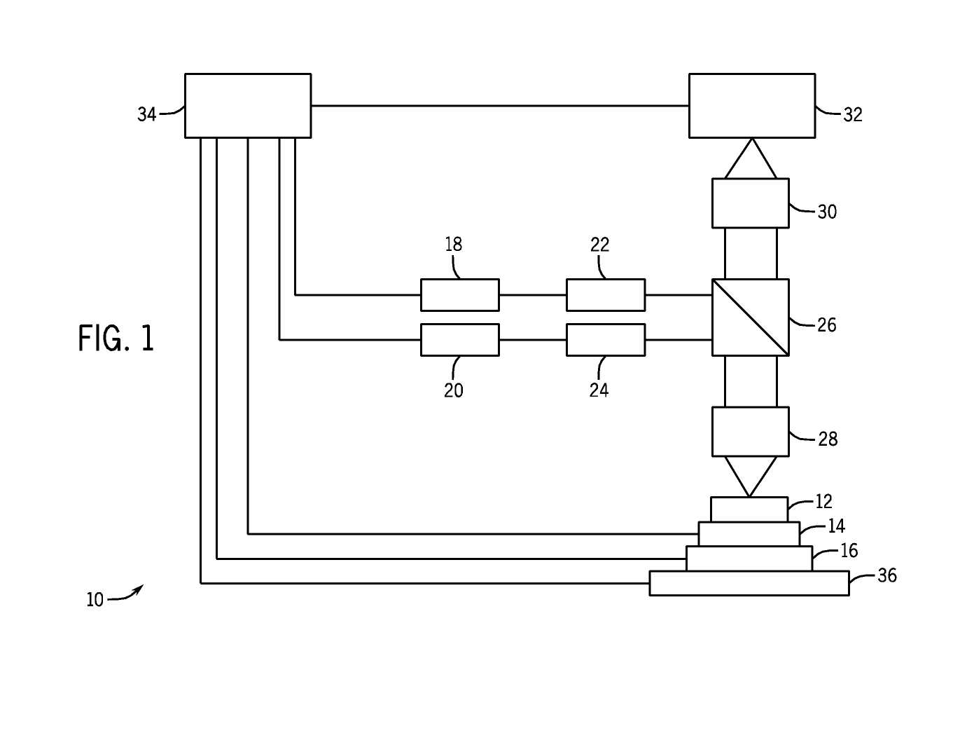

Turning now to the drawings, and referring first to FIG. 1, a biological sample imaging system 10 is illustrated diagrammatically. The biological sample imaging system 10 is capable of imaging biological components within a support structure 12. The support structure 12 may, for instance, be a flow cell with an array of biological components on its interior surfaces through which reagents, flushes, and other fluids may be introduced, such as for binding nucleotides or other molecules to the sites of biological components. The support structure 12 may be manufactured in conjunction with the present techniques or the support structure 12 may be purchased or otherwise obtained from a separate entity. Fluorescent tags on the probes or target molecules that bind to the probes may, for instance, include dyes that fluoresce when excited by appropriate excitation radiation. Assay methods that include the use of fluorescent tags and that can be used in an apparatus or method set forth herein include those set forth elsewhere herein such as genotyping assays, gene expression analysis, methylation analysis, or nucleic acid sequencing analysis.

Those skilled in the art will recognize that a flow cell may be used with any of a variety of arrays known in the art to achieve similar results. Such arrays may be formed by disposing the biological components of samples randomly or in predefined patterns on the surfaces of the support by any known technique. In a particular embodiment, clustered arrays of nucleic acid colonies can be prepared as described in U.S. Pat. No. 7,115,400; U.S. Patent Application Publication No. 2005/0100900; PCT Publication No. WO 00/18957; or PCT Publication No. WO 98/44151, each of which is incorporated herein by reference. Methods known as bridge amplification or solid-phase amplification are particularly useful for sequencing applications as described in these references. Another useful method for amplifying nucleic acid sequences on solid substrates and producing arrays for sequencing is known as emulsion PCR. Arrays can be produced by emulsion PCR methods known in the art, such as those described in Dressman et al., Proc. Natl. Acad. Sci. USA 100:8817-8822 (2003); U.S. patent Application Publication Nos. 2005/0042648, 2005/0064460, and 2005/0079510; and PCT Publication No. WO 05/010145, each of which is incorporated herein by reference.

Other exemplary random arrays that can be used in the invention include, without limitation, those in which beads are associated with a solid support, examples of which are described in U.S. Pat. Nos. 6,355,431; 6,327,410; and U.S. Pat. No. 6,770,441; U.S. Patent Application Publication Nos. 2004/0185483 and US 2002/0102578; and PCT Publication No. WO 00/63437, each of which is incorporated herein by reference. Beads can be located at discrete locations, such as wells, on a solid-phase support, whereby each location accommodates a single bead.

Any of a variety of other arrays known in the art or methods for fabricating such arrays can be used in the present invention. Commercially available microarrays that can be used include, for example, an Affymetrix® GeneChip® microarray or other microarray synthesized in accordance with techniques sometimes referred to as VLSIPS™ (Very Large Scale Immobilized Polymer Synthesis) technologies as described, for example, in U.S. Pat. Nos. 5,324,633; 5,744,305; 5,451,683; 5,482,867; 5,491,074; 5,624,711; 5,795,716; 5,831,070; 5,856,101; 5,858,659; 5,874,219; 5,968,740; 5,974,164; 5,981,185; 5,981,956; 6,025,601; 6,033,860; 6,090,555; 6,136,269; 6,022,963; 6,083,697; 6,291,183; 6,309,831; 6,416,949; 6,428,752; and 6,482,591, each of which is incorporated herein by reference. A spotted microarray can also be used in a method of the invention. An exemplary spotted microarray is a CodeLink™ Array available from Amersham Biosciences. Another microarray that is useful in the invention is one that is manufactured using inkjet printing methods such as SurePrint™ Technology available from Agilent Technologies.

Sites or features of an array are typically discrete, being separated with spaces between each other. The size of the sites and/or spacing between the sites can vary such that arrays can be high density, medium density, or low density. High density arrays are characterized as having sites separated by less than about 15 μm. Medium density arrays have sites separated by about 15 to 30 μm, while low density arrays have sites separated by greater than 30 μm. An array useful in the invention can have sites that are separated by less than 100 μm, 50 μm, 10 μm, 5 μm, 1 μm or 0.5 μm. An apparatus or method of the invention can be used to image an array at a resolution sufficient to distinguish sites at the above densities or density ranges.

As exemplified herein, a surface used in an apparatus or method of the invention is typically a manufactured surface. It is also possible to use a natural surface or a surface of a natural support structure; however the invention can be carried out in embodiments where the surface is not a natural material nor a surface of a natural support structure. Accordingly, components of biological samples can be removed from their native environment and attached to a manufactured surface.

Any of a variety of biological components can be present on a surface for use in the invention. Exemplary components include, without limitation, nucleic acids such as DNA or RNA, proteins such as enzymes or receptors, polypeptides, nucleotides, amino acids, saccharides, cofactors, metabolites or derivatives of these natural components. The biological components of a sample may be attached directly to a surface, for example, via a covalent bond. Alternatively or additionally, biological components may be disposed on a surface by binding to another molecule. For example, nucleic acids from a sample may be hybridized to surface-attached complementary nucleic acids or ligands from a sample may bind to surface-attached receptors. Although the apparatus and methods of the invention are exemplified herein with respect to components of biological samples, it will be understood that other samples or components can be used as well. For example, synthetic samples can be used such as combinatorial libraries, or libraries of compounds having species known or suspected of having a desired structure or function. Thus, the apparatus or methods can be used to synthesize a collection of compounds and/or screen a collection of compounds for a desired structure or function.

Returning to the exemplary system of FIG. 1, the biological sample imaging system 10 may include a temperature control element 14 and a subplate 16. The temperature control element 14 and subplate 16 may be used to vary and control the temperature profile of the support structure 12. However, they may also be used together to prevent the support structure 12 from warping or otherwise distorting, which may adversely affect the imaging of biological components of samples on the support structure 12. For instance, the temperature of the samples on the support structure 12 may be increased or decreased during the imaging process. Indeed, the temperature control element 14 may be used to cause temperature changes of the support structure 12. When temperature changes occur in the support structure 12, temperature changes may also occur in the temperature control element 14 and the subplate 16. However, the temperature profiles of the support structure 12, the temperature control element 14, and the subplate 16 may be controlled such that these temperature changes do not cause adverse physical changes in the subplate 16 due to thermal expansion, contraction, or other distortion. In particular, the temperature profile of the subplate 16 may be controlled by allowing fluids to flow through fluid circulating heat exchange elements within the subplate 16.

For instance, the temperature control element 14 may include a Peltier device capable of cooling or heating the support structure 12. As the support structure 12 is cooled or heated by the Peltier device, the Peltier device may also experience cooling or heating, for example, on an opposite side of the Peltier device. However, the fluid flowing through the fluid circulating heat exchange elements of the subplate 16 may be used to either introduce heat into or extract heat from the temperature control element 14, thereby maintaining the temperature profiles of the temperature control element 14 and the subplate 16. As mentioned above, doing so may minimize the amount of movement or expansion/contraction of the subplate 16 and, in turn, may allow for more reliable imaging of biological components within or on the support structure 12. Specific details of the temperature control element 14 and subplate 16 will be described in greater detail throughout this disclosure. It should be noted that both the temperature control element 14 and the subplate 16 may be located at a station (e.g., an imaging station) configured to receive a biological sample support structure 12, as discussed in further detail below.

The biological sample imaging system 10 may also include at least a first radiation source 18 but may also include a second radiation source 20 (or additional sources). The radiation sources 18, 20 may be lasers operating at different wavelengths. The selection of the wavelengths for the lasers will typically depend upon the fluorescence properties of the dyes used to image the component sites. Multiple different wavelengths of the lasers used may permit differentiation of the dyes at the various sites within or on the support structure 12, and imaging may proceed by successive acquisition of a series of images to enable identification of the molecules at the component sites in accordance with image processing and reading logic generally known in the art. Other radiation sources known in the art can be used including, for example, an arc lamp or quartz halogen lamp. Particularly useful radiation sources are those that produce electromagnetic radiation in the ultraviolet (UV) range (about 200 to 390 nm), visible (VIS) range (about 390 to 770 nm), infrared (IR) range (about 0.77 to 25 microns), or other range of the electromagnetic spectrum.

For ease of description, embodiments utilizing fluorescence-based detection are used as examples. However, it will be understood that other detection methods can be used in connection with the apparatus and methods set forth herein. For example, a variety of different emission types can be detected such as fluorescence, luminescence, or chemiluminescence. Accordingly, components to be detected can be labeled with compounds or moieties that are fluorescent, luminescent, or chemiluminescent. Signals other than optical signals can also be detected from multiple surfaces using apparatus and methods that are analogous to those exemplified herein with the exception of being modified to accommodate the particular physical properties of the signal to be detected.

Output from the radiation sources 18, 20 may be directed through conditioning optics 22, 24 for filtering and shaping of the beams. For example, in a presently contemplated embodiment, the conditioning optics 22, 24 may generate a generally linear beam of radiation, and combine beams from multiple lasers, for example, as described in U.S. Pat. No. 7,329,860, which is incorporated herein by reference. The laser modules can additionally include a measuring component that records the power of each laser. The measurement of power may be used as a feedback mechanism to control the length of time an image is recorded in order to obtain uniform exposure, and therefore more readily comparable signals.

After passing through the conditioning optics 22, 24, the beams may be directed toward directing optics 26 which redirect the beams from the radiation sources 18, 20 toward focusing optics 28. The directing optics 26 may include a dichroic minor configured to redirect the beams toward the focusing optics 28 while also allowing certain wavelengths of a retrobeam to pass therethrough. The focusing optics 28 may confocally or semi-confocally direct radiation to one or more surfaces 18, 20 of the support structure 12 upon which individual biological components are located. For instance, the focusing optics 28 may include a microscope objective that semi-confocally directs and concentrates the radiation sources 18, 20 along a line to a surface of the support structure 12.

Biological component sites on the support structure 12 may fluoresce at particular wavelengths in response to an excitation beam and thereby return radiation for imaging. For instance, the fluorescent components may be generated by fluorescently tagged nucleic acids that hybridize to complementary molecules of the components or to fluorescently tagged nucleotides that are incorporated into an oligonucleotide using a polymerase. As noted above, the fluorescent properties of these components may be changed through the introduction of reagents into the support structure 12 (e.g., by cleaving the dye from the molecule, blocking attachment of additional molecules, adding a quenching reagent, adding an acceptor of energy transfer, and so forth). As will be appreciated by those skilled in the art, the wavelength at which the dyes of the sample are excited and the wavelength at which they fluoresce will depend upon the absorption and emission spectra of the specific dyes. Such returned radiation may propagate back through the directing optics 26. This retrobeam may generally be directed toward detection optics 30 which may filter the beam such as to separate different wavelengths within the retrobeam, and direct the retrobeam toward at least one detector 32.

The detector 32 may be based upon any suitable technology, and may be, for example, a charged coupled device (CCD) sensor that generates pixilated image data based upon photons impacting locations in the device. However, it will be understood that any of a variety of other detectors may also be used including, but not limited to, a detector array configured for time delay integration (TDI) operation, a complementary metal oxide semiconductor (CMOS) detector, an avalanche photodiode (APD) detector, a Geiger-mode photon counter, or any other suitable detector. TDI mode detection can be coupled with line scanning as described in U.S. Pat. No. 7,329,860, which is incorporated herein by reference.

The detector 32 may generate image data, for example, at a resolution between 0.1 and 50 microns, which is then forwarded to a control/processing system 34. In general, the control/processing system 34 may perform various operations, such as analog-to-digital conversion, scaling, filtering, and association of the data in multiple frames to appropriately and accurately image multiple sites at specific locations on a sample. The control/processing system 34 may store the image data and may ultimately forward the image data to a post-processing system (not shown) where the data are analyzed. Depending upon the types of sample, the reagents used, and the processing performed, a number of different uses may be made of the image data. For example, nucleotide sequence data can be derived from the image data, or the data may be employed to determine the presence of a particular gene, characterize one or more molecules at the component sites, and so forth. The operation of the various components illustrated in FIG. 1 may also be coordinated with the control/processing system 34. In a practical application, the control/processing system 34 may include hardware, firmware, and software designed to control operation of the radiation sources 18, 20, movement and focusing of the focusing optics 28, a translation system 36, and the detection optics 30, and acquisition and processing of signals from the detector 32. The control/processing system 34 may thus store processed data and further process the data for generating a reconstructed image of irradiated sites that fluoresce within the support structure 12. The image data may be analyzed by the system itself, or may be stored for analysis by other systems and at different times subsequent to imaging.

The support structure 12, the temperature control element 14, and the subplate 16 may be supported by the translation system 36 which allows for focusing and movement of the support structure 12 before and during imaging. The stage may be configured to move the support structure 12, thereby changing the relative positions of the radiation sources 18, 20 and detector 32 with respect to the surface bound biological components for progressive scanning. Movement of the translation system 36 can be in one or more dimensions including, for example, one or both of the dimensions that are orthogonal to the direction of propagation for the excitation radiation line, typically denoted as the X and Y dimensions. In particular embodiments, the translation system 36 may be configured to move in a direction perpendicular to the scan axis for a detector array. A translation system 36 useful in the present invention may be further configured for movement in the dimension along which the excitation radiation line propagates, typically denoted as the Z dimension. Movement in the Z dimension can also be useful for focusing.

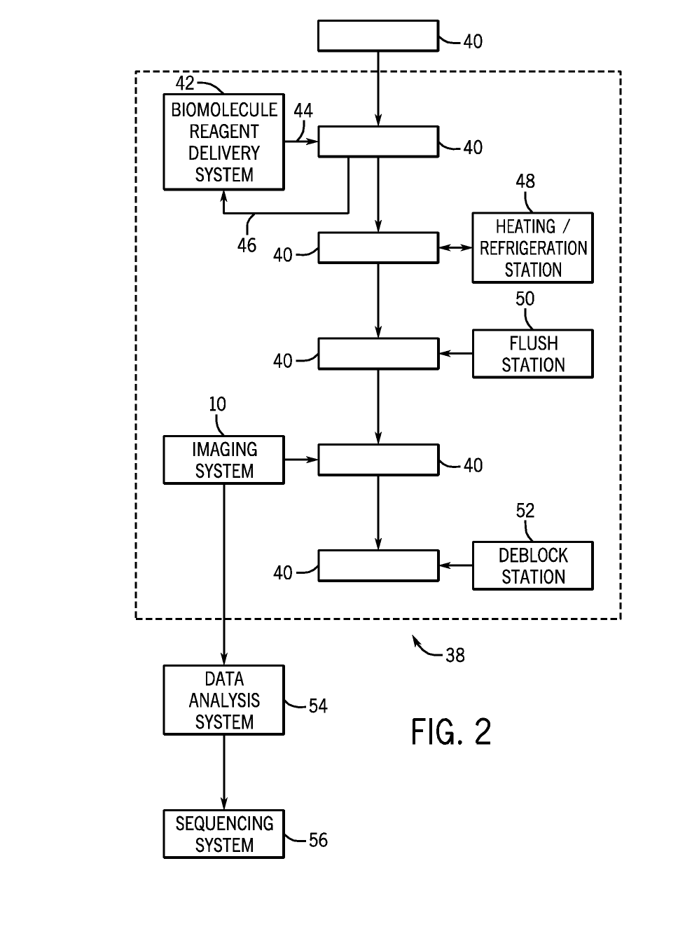

FIG. 2 is a diagrammatical overview of a biological sample processing system 38 which may employ a biological sample imaging system 10 of the type discussed with reference to FIG. 1. In general, system 38 may include a plurality of stations through which samples in sample containers 40 progress. The system may be designed for cyclic operation in which reactions are promoted with single nucleotides or with oligonucleotides, followed by flushing, imaging and de-blocking in preparation for a subsequent cycle. In a practical system, the samples 40 may be circulated through a closed loop path for sequencing, synthesis or ligation, for example, as described in U.S. patent application Ser. No. 12/020,721 and PCT Publication No. WO 2008/092150, each of which is incorporated herein by reference.

In the illustrated embodiment, a reagent delivery system 42 provides a process stream 44 to a sample container 40. As discussed with reference to FIG. 1, the effluent stream 46 from the container may be recaptured and recirculated in the nucleotide delivery system, for recapture of enzymes, nucleotides and oligonucleotides (where used) from the effluent stream, for example, as described in U.S. patent application Ser. No. 12/020,297, which is incorporated herein by reference. These are recycled, such as with additional enzymes, nucleotides or oligonucleotides being added, as discussed above with reference to FIG. 1. The sample container 40 may, in certain circumstances, be heated or refrigerated at a heating and refrigeration station 48. Specifically, the heating or refrigeration of fluids interacting with the sample container 40 may help facilitate the reaction of the fluids with biological samples within the sample container 40. In addition, the heating and refrigeration station 48 may, under certain circumstances, function as a staging location where the sample containers 40 may be stored prior to imaging.

In the illustrated embodiment, the sample container 40 may be flushed at a flush station 50 to remove additional reagents and to clarify the sample for imaging. The sample may then be moved to a biological sample imaging system 10 where image data may be generated that can be analyzed for determination of the sequence of a progressively building oligonucleotide chain, such as based upon a known template as described below. In a presently contemplated embodiment, for example, biological sample imaging system 10 may employ semi-confocal line scanning to produce progressive pixilated image data that can be analyzed to locate individual sites in an array and to determine the type of nucleotide that was most recently attached or bound to each site. Following biological sample imaging system 10, then, the samples may progress to a de-blocking station 52 in which a blocking molecule or protecting group is cleaved from the last added nucleotide, along with the marking dye.

In a typical sequencing system, then, image data from the biological sample imaging system 10 may be stored and forwarded to a data analysis system, as indicated generally at reference numeral 54. The analysis system may typically include a general purpose or application-specific programmed computer providing for user interface and automated or semi-automated analysis of the image data to determine which of the four common DNA nucleotides was last added at each of the sites in an array of each sample. As will be appreciated by those skilled in the art, such analysis is typically performed based upon the color of unique tagging dyes for each of the four common DNA nucleotides. However, tags having other distinguishing properties, whether detectable by imaging or any other useful method, can be used if desired including, for example, tags having those properties set forth above in regard to the detection system of FIG. 1. This image data is further analyzed by a sequencing system 56 which may derive sequence data from the image data, and piece together sequence data for a multitude of oligonucleotides or DNA fragments to provide more comprehensive genomic mapping of a particular individual or population.

Although sample processing is exemplified in FIG. 2, and elsewhere herein, for an embodiment in which a sample container 40 progresses through various stations, it will be understood that one or more of the functions described as occurring at these stations can occur instead at a single station. Thus, in particular embodiments, the sample container 40 may remain in contact with a heat exchange device while reagent delivery, flushing, imaging and/or de-blocking is carried out. For example, the sample container 40 may remain at a fixed location while one or more functions occur.

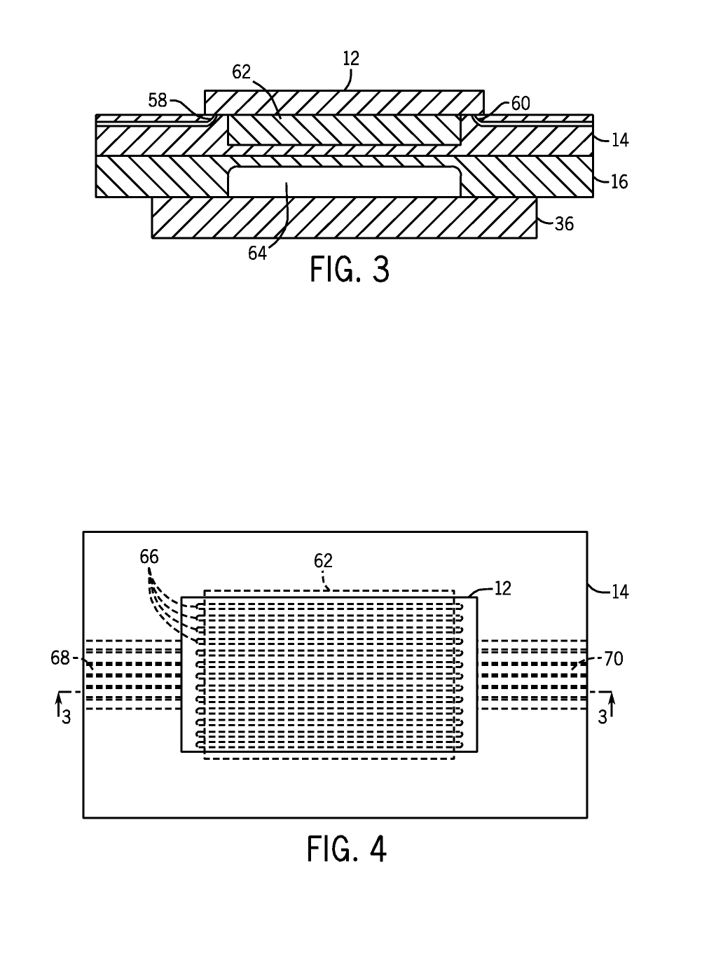

As discussed above, the biological sample imaging system 10 may include the support structure 12, the temperature control element 14, and the subplate 16. FIG. 3 is a sectional side view of an exemplary support structure 12, temperature control element 14, subplate 16, and translation system 36 using temperature control techniques in accordance with the present invention. As shown, the support structure 12 may be located on top of the temperature control element 14. Inlet conduit 58 and outlet conduit 60 may be used in certain embodiments where reagents are introduced into the support structure 16 for interaction with biological components of samples within or on the support structure 12. It should be noted that while the inlet conduit 58 and outlet conduit 60 are depicted as flowing into and out of the bottom of the support structure 12, they may in fact be connected in various ways such as, for instance, allowing fluid to flow through either the top or bottom of the support structure 12.

The temperature control element 14 may include a Peltier device 62 or some other thermoelectric heat exchange device capable of cooling and/or heating the support structure 12. Such device may be used to transfer heat to or form one side of the Peltier device 62 to an opposite side of the Peltier device 62. In doing so, heat may either be introduced into or extracted from one side of the support structure 12. However, the other side of the Peltier device 62 may also experience a change in temperature. This change in temperature, if uncontrolled, may cause problems such as thermal expansion or contraction, warping, or other distortions of the subplate 16 which may ultimately adversely affect the imaging process.

Therefore, the subplate 16 may be equipped with a fluid circulating heat exchange element 64 which may help maintain a substantially constant (e.g., less than 1-2° F. temperature change during the imaging process) temperature throughout the subplate 16 such that these distortions are minimized. The fluid circulating heat exchange element 64 may, for instance, include a series of interconnected channels through which a fluid may flow. The fluid flowing through the channels may, for instance, be water, methanol, propylene glycol, ethylene glycol, or mixtures thereof. In the situation where the fluid circulating heat exchange element 64 is used to cool the bottom side of the temperature control element 14, the fluid within the channels of the fluid circulating heat exchange element 64 may extract heat from the bottom side of the temperature control element 14. In contrast, whenever the bottom side of the temperature control element 14 begins cooling down, it may be desirable for the fluid in the channels of the fluid circulating heat exchange element 64 to transfer heat to the temperature control element 14.

It should be noted that in the illustrated embodiment, there is space between the Peltier device 62 and the fluid circulating heat exchange element 64. However, the space shown is merely for illustration purposes to distinguish these individual components from the respective layers (e.g., the temperature control element 14 and the subplate 16) in which the components may be located. In practice, the Peltier device 62 and fluid circulating heat exchange element 64 may, in fact, be adjacent to each other in order to facilitate heat transfer between these components.

FIG. 4 is a top view of an exemplary support structure 12 and temperature control element 14 using temperature control techniques in accordance with the present invention. This view illustrates more particularly how the support structure 12 and the temperature control element 14 may interact. As shown, the Peltier device 62 may be positioned within the temperature control element 14 such that a substantial portion of the Peltier device 62 may be positioned directly under the support structure 12, thereby maximizing the heat transfer to and from the Peltier device 62 and the support structure 12. In particular, the Peltier device 62 may be positioned such that a substantial portion of the Peltier device 62 may correspond to the positioning of the flow lanes 66 of the support structure 12. This may ensure that the heat transfer between the Peltier device 62 and the support structure 12 more effectively targets the reagents and biological samples within the flow lanes 66. An inlet manifold 68 and an outlet manifold 70 may be used to facilitate the flow of the reagents through the support structure 12. These manifolds 68, 70 may, for instance, replace the somewhat simplified inlet conduit 58 and outlet conduit 60 illustrated in FIG. 3 and may include more complex designs, as discussed below. Specifically, in certain embodiments, these manifolds 68, 70 may be separate components which may be located on top of the temperature control element 14 and connect directly to opposite ends of the support structure 12.

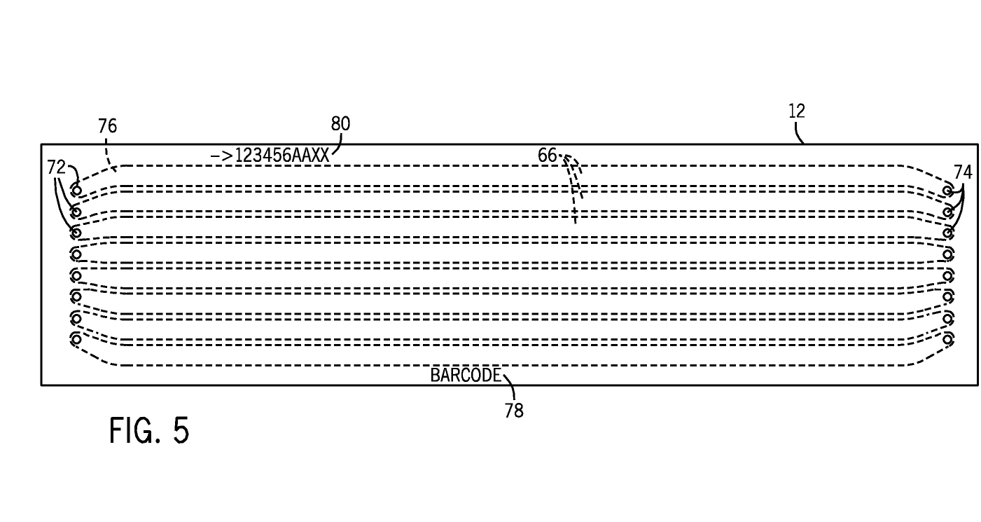

The support structure 12 may be any of a number of various designs and may incorporate several features. For example, FIG. 5 is a top view of an exemplary support structure 12 configured for use with the temperature control techniques in accordance with the present invention. As illustrated in FIG. 5, the flow lanes 66 of the support structure 12 may not strictly be parallel in nature. Rather, as shown, the flow lanes 66 may be characterized by a “banana shaped” configuration, wherein the inlets 72 and outlets 74 of the flow lanes 66 are located closer together than the flow lanes 66 themselves. The design shape shown in FIG. 5 provides an advantage of increasing the volume of the flow lanes 66 while maintaining the inlets 72 and outlets 74 at a spacing that is the same as the spacing used for smaller volume flow lanes 66. Thus, in accordance with the invention, different flow lanes 66 on a particular support structure 12 may have shapes that differ from each other such that the flow lanes 66 will have substantially similar volumes and will be accommodated within other structural parameters, such as the overall shape of the support structure 12, the spacing of inlets 72 and outlets 74, or the like. In particular, in this embodiment, the flow lanes 66 may include bends 76 near the inlets 72 and outlets 74 which cause the flow lanes 66 to gradually curve towards their respective inlets 72 and outlets 74. However, at least a portion of the flow lanes 66 are parallel to each other and have one or more dimensions that are substantially the same. For example as shown in FIG. 5, the parallel portions of the flow lanes 66 occurring between the curved portions (i.e. the portions excluding the bent portions) have substantially the same widths such that the parallel portions present similar sized surface areas for imaging.

In addition to the shape of the flow lanes 66 illustrated in FIG. 5, the support structure 12 may also include various means for cataloging the support structure 12. For example, the support structure 12 may include bar codes 78 or alphanumeric codes 80 which may be used to catalog and track the support structures 12. It should be noted that the particular design of the support structure 12 illustrated in FIG. 5 is merely exemplary and not intended to be limiting. Various other support structure 12 designs may be implemented.

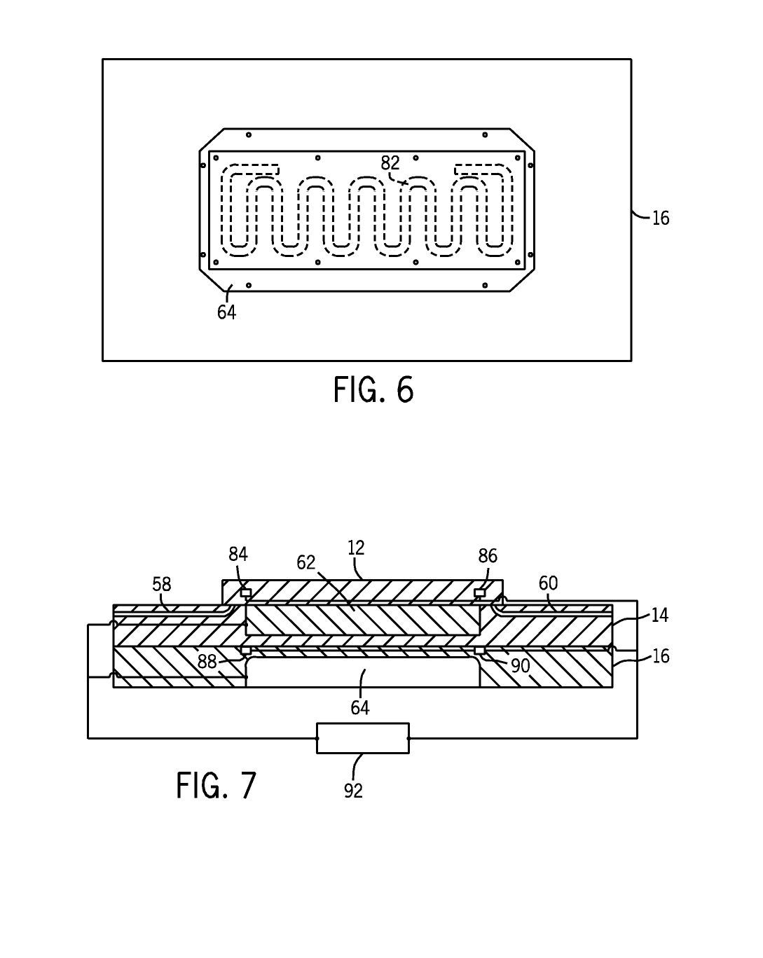

FIG. 6 is a top view of an exemplary subplate 16 using temperature control techniques in accordance with the present invention. As discussed above, the fluid circulating heat exchange element 64 of the subplate 16 may contain fluid circulating heat exchange channels 82 through which a fluid, such as water, methanol, propylene glycol, ethylene glycol, or mixtures thereof, may flow and help maintain the subplate 16 at a substantially constant temperature despite temperature changes in the Peltier device 62 of the temperature control element 14. As shown, the fluid circulating heat exchange channels 82 may be a single channel with one inlet and one outlet. In this particular embodiment, the channel may wind from side to side of the fluid circulating heat exchange element 64 in order to maximize the surface area of the fluid circulating heat exchange element 64 which may be used to counteract temperature changes created by the Peltier device 62 of the temperature control element 14. However, other embodiments of the fluid circulating heat exchange channels 82 may also be utilized. For instance, the fluid circulating heat exchange channels 82 may include a series of parallel channels extending from one side of the fluid circulating heat exchange element 64 to an opposite side of the fluid circulating heat exchange element 64.

Regardless of the specific design of the fluid circulating heat exchange element 64 and associated fluid circulating heat exchange channels 82, control of the flow through these elements may ensure the subplate 16 remains at a substantially constant temperature. FIG. 7 is another sectional side view of an exemplary support structure 12, temperature control element 14, and subplate 16 using temperature control techniques in accordance with the present invention. As shown, the system may be equipped with multiple temperature sensors. For instance, in the illustrated embodiment, support structure inlet temperature sensor 84, support structure outlet temperature sensor 86, and subplate temperature sensors 88, 90 may be used to monitor various temperatures throughout the system. In particular, the support structure inlet temperature sensor 84 and support structure outlet temperature sensor 86 may be used to monitor the temperatures of the fluid introduced into, present in, or exiting from the support structure 12. These temperatures, among others, may be used to indicate general temperature changes as they occur during the imaging process.

However, of perhaps greater importance in the present context, subplate temperature sensors 88, 90 may be used to monitor temperature changes in the subplate 16. These and many other temperature readings may be taken by sensors to determine when and where temperatures are changing too greatly or where excessive temperature gradients between components have been created. These temperature readings may be compiled by a temperature control unit 92 which may process this information from the sensors and determine when corrective action should be taken by the Peltier device 62, the fluid circulating heat exchange element 64, or other components of the system. For instance, if the temperature readings from the subplate temperature sensors 88, 90 begin to increase beyond a certain limit (e.g., the 1-2° F. difference discussed above as indicating a “substantially constant” temperature of the subplate 16), instructions may be sent to the fluid circulating heat exchange element 64 to, for instance, increase the flow rate of the fluid flowing through the fluid circulating heat exchange channels 82 of the fluid circulating heat exchange element 64, assuming that the temperature of the fluid within the fluid circulating heat exchange channels 82 is lower than the temperature sensed by the subplate temperature sensors 88, 90. Instructions may also be sent to the heating and refrigeration station 48, discussed above with respect to FIG. 2, which may be used to cool or heat fluid, for example, at a reservoir located at a distance away from the sample detection area. In addition, instructions may also be sent to the Peltier device 62 to, for instance, increase or decrease the amount of heat introduced into or extracted from the support structure 12. Again, these examples are merely illustrative and not intended to be limiting. Many other scenarios of temperature variations may occur and many different response actions may be implemented. In addition, the temperature control unit 92 may be configured to communicate and work together with the control/processing system 34 (not shown) discussed above to more effectively coordinate the cooling or heating of the support structure 12, the temperature control element 14, and the subplate 16 with the other operations of the biological sample imaging system 10.

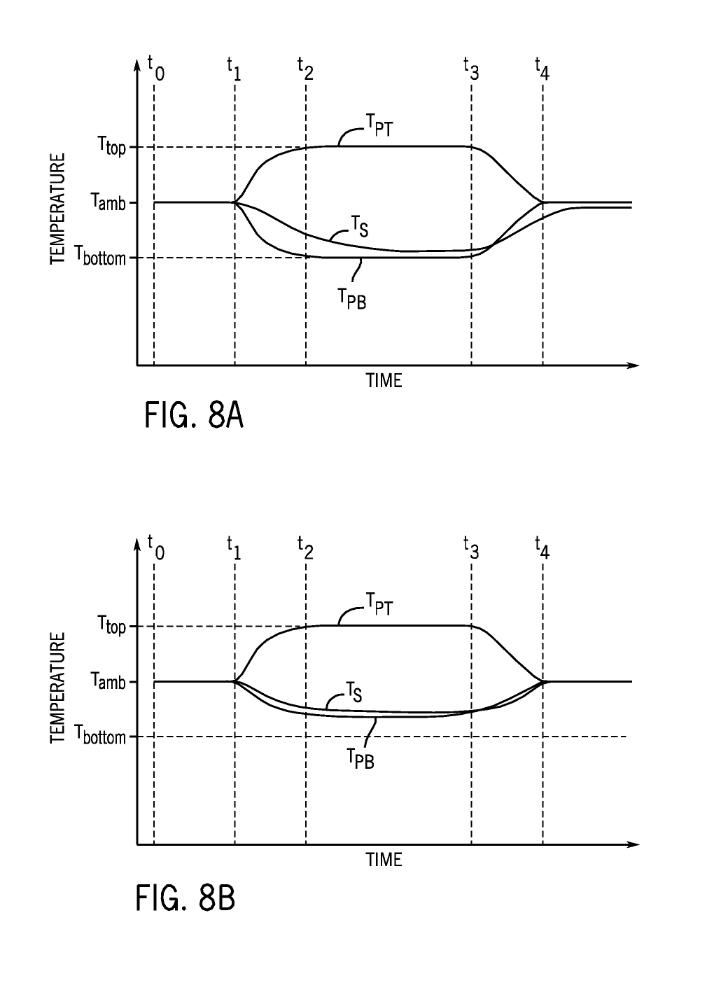

Therefore, the temperature of the subplate 16 may be maintained at a substantially constant (e.g., within 1-2° F.) temperature through the imaging process. For illustrative purposes, FIGS. 8A and 8B are charts of exemplary temperature changes of the temperature control element 14 and subplate 16 over time in accordance with the present invention. More particularly, FIG. 8A illustrates how the temperature T_{PT} at the top of the Peltier device 62, the temperature T_{PB} at the bottom of the Peltier device 62, and the temperature T_{S} of the subplate 16 may change over time if the fluid circulating heat exchange element 64 is not used. In the illustrated scenario, at time t₀, all of the temperatures may be the same at some ambient temperature T_{amb}. However, at time t₁, the Peltier device 62 may be activated such that the temperature T_{PT} of the top of the Peltier device 62 may gradually move toward Tₜₒₚ while the temperature T_{PB} of the bottom of the Peltier device 62 may gradually move toward T_{bottom} by time t₂. In this scenario, since the fluid circulating heat exchange element 64 is not being used, the temperature T_{S} of the subplate 16 may simply be gradually affected by the temperature T_{PB} of the bottom of the Peltier device 62. Conversely, at time t₃ when the Peltier device 62 may be deactivated, the temperatures T_{PT} and T_{PB} of the top and bottom of the Peltier device 62 may gradually move back toward T_{amb} by time t₄. However, again, the temperature T_{S} of the subplate 16 may simply be gradually affected by the temperature T_{PB} of the bottom of the Peltier device 62.

However, FIG. 8B illustrates how the temperature T_{PB} at the bottom of the Peltier device 62 and the temperature T_{S} of the subplate 16 may change in a different manner using the temperature control techniques of the present invention. In this scenario, the temperature T_{PT} of the top of the Peltier device 62 may not be any different than illustrated above in FIG. 8A. For instance, the temperature T_{PT} of the top of the Peltier device 62 may simply increase from T_{amb} to Tₜₒₚ from time t₁ to time t₂ and decrease from Tₜₒₚ back to T_{amb} from time t₃ to time t₄. However, using the temperature control techniques of the present invention, the temperature decreases of the bottom of the Peltier device 62 and the subplate 16 may be minimized. In particular, at time t₁, instead of the temperature T_{PB} of the bottom of the Peltier device 62 gradually moving toward T_{bottom} by time t₂, the fluid circulating heat exchange element 64 may help control the temperature T_{S} of the subplate 16 such that both the temperature T_{PB} of the bottom of the Peltier device 62 and the T_{S} of the subplate 16 change by a lesser amount than illustrated in FIG. 8A. This is illustrative of how the Peltier device 62 and the fluid circulating heat exchange element 64 may work together to minimize the temperature changes of both the temperature control element 14 and the subplate 16.

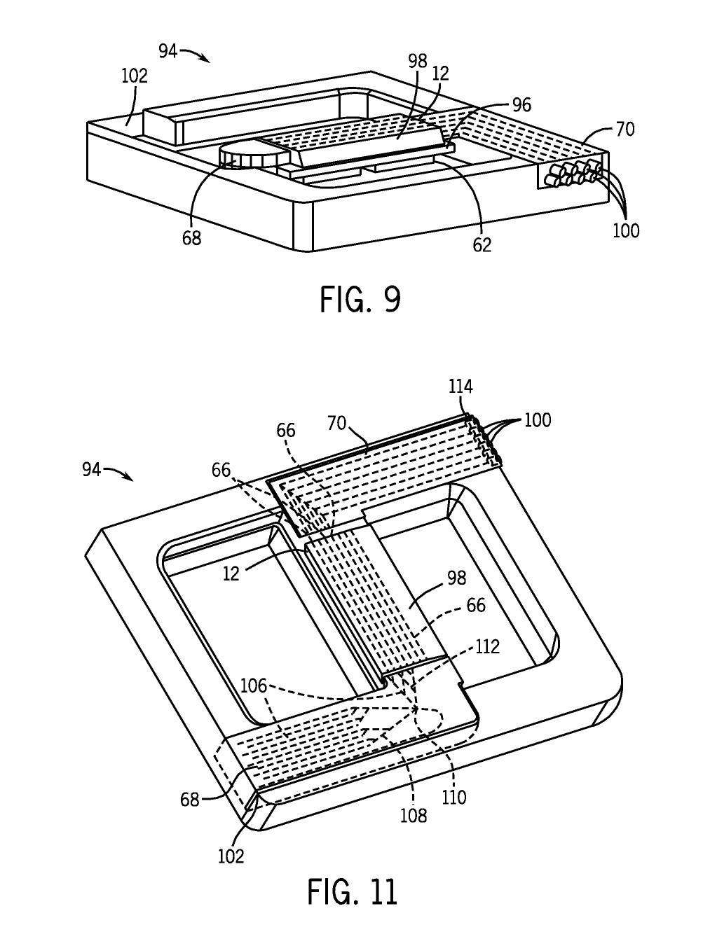

As a practical matter, in certain embodiments, the support structure 12, temperature control element 14, and subplate 16 may be integrated into a single functioning subsystem of the biological sample imaging system 10. FIG. 9 is an isometric view of an exemplary embodiment of a holder bench 94 incorporating the support structure 12, temperature control element 14, and subplate 16 and using the temperature control techniques of the present invention. More particularly, in the illustrated embodiment, the holder bench 94 may include a thermal plate 96. The thermal plate 96 may be situated between the support structure 12 and the Peltier device 62. In addition, the thermal plate 96 may help maintain uniform temperature control. In the illustrated embodiment, the support structure 12 may include or be located adjacent to a prism 98 which may be thermally bonded to the thermal plate 96. As described in greater detail below, the prism 98 may aid in the imaging processes, particularly when using TIRF-related imaging techniques. In addition, temperature feedback mechanisms may be embedded in the prism 98 to ensure that the support structure 12 remains at a desired set temperature and that thermal resistance effects of the prism 98 are minimized. The Peltier device 62 may be soldered to the thermal plate 96 and may, as illustrated, comprise multiple devices, depending on the particular configuration. The holder bench 94 may also include an inlet manifold 68 which may help control the flow of reagents through the support structure 12. Fluids may optionally be pre-heated when passing through the inlet manifold 68. In addition, the holder bench 94 may include an outlet manifold 70 which, as illustrated, may include a series of outlet manifold tubes 100 through which fluid used within the support structure 12 may exit the holder bench 94. In the illustrated embodiment, the holder bench 94 may be used as part of the fluid circulating heat exchange element 64, discussed above.

In some embodiments, the support structure 12 may be held to the holder bench 94 and, more specifically, to the prism 98, the thermal plate 96, or some other component of the holder bench 94 using one or more clamps. However, in other embodiments, the support structure 12 may be held to the holder bench 94 through vacuum chucking rather than clamps. Throughout this disclosure, methods of holding the support structure 12 and/or prism 98 in place on the holder bench 94 using vacuum forces will be referred to simply as “vacuum chucking.” Thus, a vacuum may hold the support structure 12 in position on the holder bench 94 so that proper illumination and imaging may occur. Accordingly, certain embodiments may also include one or more vacuum creation devices (not shown) for creating a vacuum (or partial vacuum) to hold the support structure 12 and/or prism 98 to the holder bench 94, translation stage 36, and so forth. The holder bench 94 may have vacuum channels that occupy an area within the footprint of the support structure 12. Such vacuum channels may function to distribute vacuum along the support structure 12 for a more uniform seal than would be available from a single point of vacuum contact.

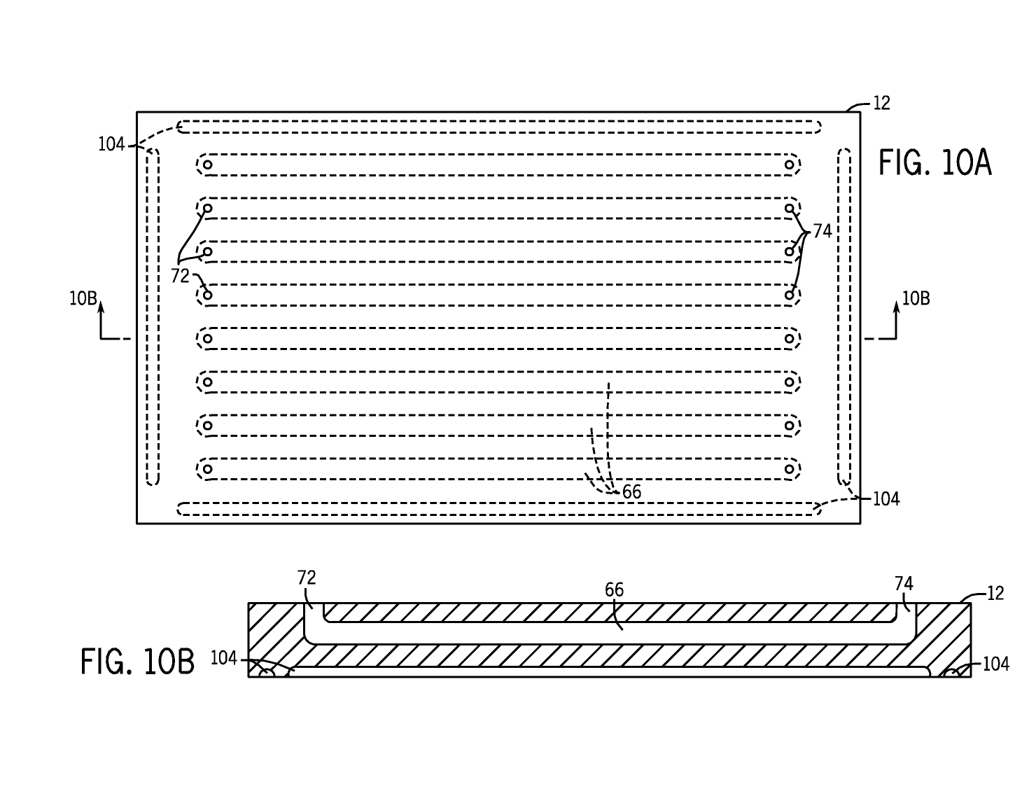

Support structures 12 may be configured such that vacuum channels occur at the periphery of the support structure 12. For example, FIGS. 10A and 10B are a top and side view of an exemplary embodiment of a support structure 12 including vacuum channels 104 along its periphery. The vacuum channels 104 may be present only at the periphery of the footprint and on all sides of the footprint. Although illustrated as four separate vacuum channels 104 located along the periphery of the support structure 12, in certain embodiments, the vacuum channels 104 may be connected and form one continuous ring along the periphery of the support structure 12.

An advantage of using the vacuum channels 104 is that vacuum forces applied through the channel(s) will pull on the space between the support structure 12 and the holder bench 94, such that warping of the support structure 12 may be prevented. The use of peripheral vacuum channel(s) 104 may also provide advantages for TIRF-related approaches by facilitating even distribution of a layer of index matched fluid between the support structure 12 and the prism 98 through which excitation light may be delivered to the surface of the support structure 12. Thus, the invention provides a method of delivering a droplet of index matched fluid to a surface, such as the prism 98 or holder bench 94; placing a support structure 12 on the surface, wherein the periphery of the support structure 12 may have one or more vacuum channels 104; and applying vacuum to the one or more vacuum channels 104, whereby the index matched fluid may be caused to spread as a thin layer at the interface between the support structure 12 and the prism 98.

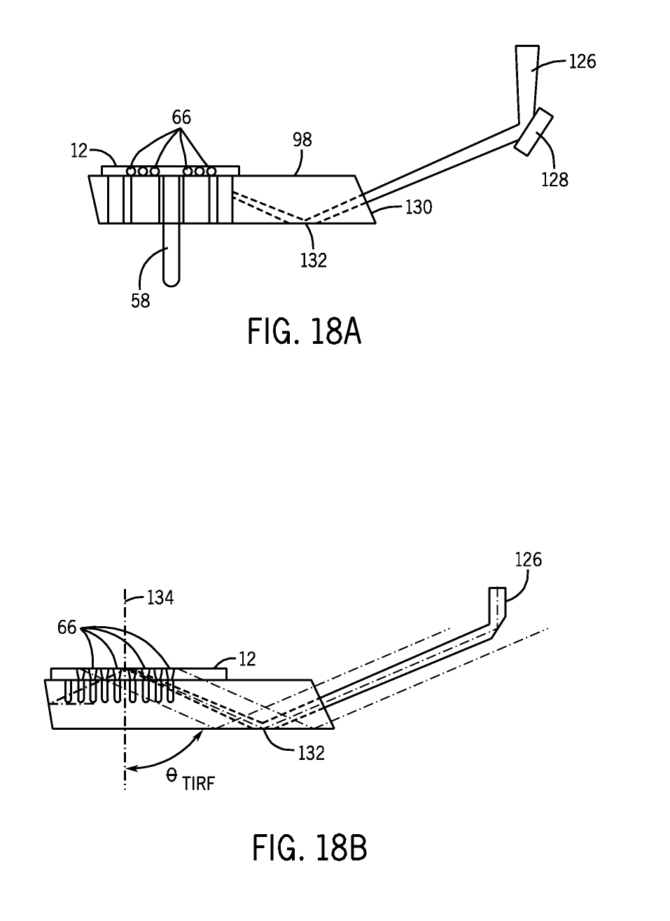

Having peripheral vacuum channel(s) 104 on the support structure 12 rather than on the holder bench 94 or the prism 98 may also provide an optical advantage for TIRF-related approaches. An excitation beam delivered to the support structure 12 for TIRF is delivered at an angle (as shown, for example, in FIG. 18). A channel in the holder bench 94 or the prism 98 may block or distort an excitation beam that is reflected from the bottom of the prism toward the bottom side of support structure 12, thereby reducing access of the excitation beam to the region of the support structure 12 that is at the edge adjacent to the channel. On the other hand, the channel occurring in the support structure 12 may be outside of the path of the excitation beam that is reflected from the bottom of the prism toward the bottom side of support structure 12, thereby affording the beam access to regions of the lower surface of the support structure 12 that are close to the edge.

Returning now to FIG. 9, in particular embodiments, the support structure 12 and/or prism 98 may be held to the holder bench 94 through the use of vacuum channels in the bottom of the support structure 12 and/or prism 98. Thus, in some embodiments, vacuum channels may not be present on the holder bench 94, but may instead be present on the underside of the support structure 12. The vacuum channels on the underside of the support structure 12 may be provided in a configuration to mate with a vacuum opening on the holder bench 94. There may be several, non-limiting advantages to providing vacuum channels on the underside of the support structure 12 rather than on the contact surface of holder bench 94. First, the holder bench 94 may have a smooth surface making it easier to wipe clean than if it were to have channels. Thus, in embodiments where the holder bench 94 is used repeatedly with disposable support structures 12, the reusable surface may be provided in an easy to maintain configuration while providing the advantages of vacuum channels for purposes of chucking.

FIG. 11 is an isometric view of a more detailed exemplary embodiment of a holder bench 94 incorporating the support structure 12, temperature control element 14, and subplate 16 and using the temperature control techniques of the present invention. This embodiment shows an inlet manifold 68 of a different form than shown in FIG. 9. This inlet manifold 68 may be located within a hollowed-out recess 102 of the holder bench 94. In contrast, in FIG. 9, the inlet manifold recess 102 of the holder bench 94 is illustrated as not being occupied. In the embodiment illustrated in FIG. 11, the inlet manifold 68 may be inserted into the inlet manifold recess 102 and an end of the inlet manifold 68 may be connected to the support structure 12 such that reagent inlet lines 106 of the inlet manifold 68 correspond to flow lanes 66 of the support structure 12. As illustrated, the inlet manifold 68 may include a series of converging and diverging reagent inlet lines 106 which may converge through a binary combiner 108 to a single point, such as an inlet valve 110 of the inlet manifold 68. From this convergent point, the reagent inlet lines 106 may diverge through a binary splitter 112 and then connect with the flow lanes 66 of the support structure 12. It should be noted that the outlet manifold 70 may also be similarly removable and allowed to slide into and out of an outlet manifold recess 114 of the holder bench 94. In other embodiments, the inlet and outlet manifold recesses 102, 114 may not be used and the inlet and outlet manifolds 68, 70 may generally be stationary on the holder bench 94.

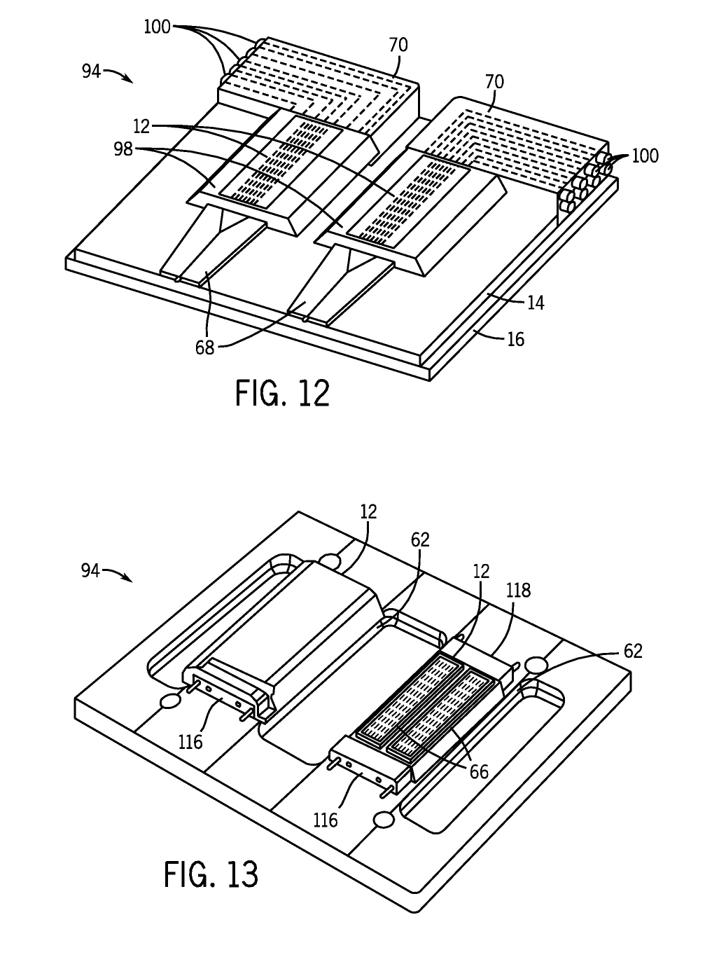

FIG. 12 is an isometric view of another exemplary embodiment of a holder bench 94 incorporating support structures 12, temperature control element 14, and subplate 16 and using the temperature control techniques of the present invention. In this embodiment, however, multiple support structures 12, inlet manifolds 68, and outlet manifolds 70 may be used simultaneously. In addition, multiple prisms 98 and multiple sets of outlet manifold tubes 100 may be used. Allowing for multiple support structures 12 and other associated components may allow for increased flexibility in the imaging process beyond simply providing increased surface area of the support structures 12 to be imaged. As will be discussed in greater detail below, the exact layout of the support structures 12 on the holder bench 94 may also allow for imaging to be performed on multiple support structures 12 at the same time. The techniques for simultaneous imaging of multiple support structures 12 may prove particularly useful with TIRF-related imaging techniques.

FIG. 13 is an isometric view of another exemplary embodiment of the holder bench 94 illustrated in FIG. 12. In this view, however, the inlet and outlet manifolds 68, 70 have been removed to show in more detail how the inlet and outlet manifolds 68, 70 may be located on top of the holder bench 94 and may be removable from inlet and outlet connectors 116, 118 associated with the support structures 12. Each support structure 12 may be located on top of a Peltier device 62 for cooling or heating the respective support structure 12. In addition, this illustrated embodiment shows how the support structures 12 may include multiple sets of flow lanes 66. This may also allow for increased flexibility of the imaging process.

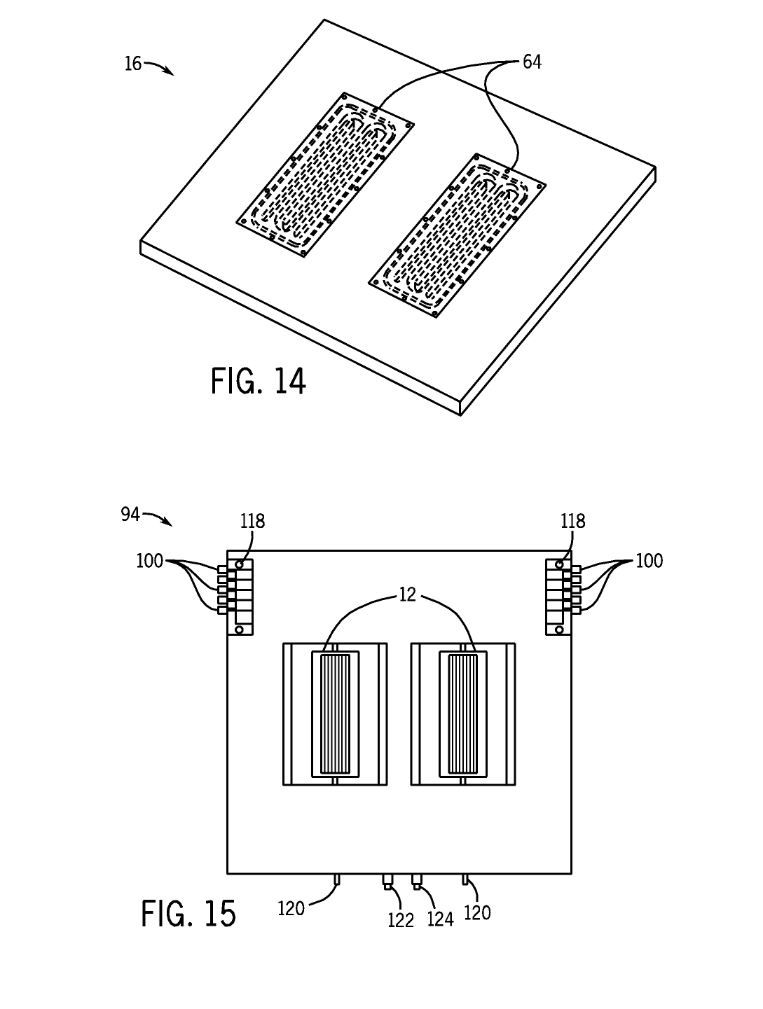

FIG. 14 is an isometric view of an exemplary embodiment of the subplate 16 layer of the holder bench 94 illustrated in FIG. 12. This view shows how multiple fluid circulating heat exchange elements 64 may be used in conjunction with the multiple support structures 12 (not shown) and associated multiple Peltier devices 62 (not shown) discussed in FIGS. 10 and 11. The exact configuration of the fluid circulating heat exchange elements 64 may vary with the specific implementation. In general, it may be desirable to have each individual fluid circulating heat exchange element 64 of the same general shape as its respective supports structure 12 and Peltier device 62 in order to maximize the heat transfer between the components. However, in certain embodiments, a single fluid circulating heat exchange element 64 may correspond to multiple support structures 12 and/or multiple Peltier devices 62. For instance, in systems where the cooling or heating characteristics may be consistent between support structures 12, it may be acceptable to use a single fluid circulating heat exchange element 64.

Although application of the temperature control devices and methods are exemplified in FIGS. 10 through 14 and elsewhere herein with regard to each support structure 12 being in thermal contact with a dedicated first heat exchange device and each first heat exchange device being in thermal contact with a dedicated second heat exchange device, it will be understood that other configurations where one or both of the heat exchange devices are shared may be used. For example, two or more support structures 12 may be in thermal contact with a single first heat exchange device and the single first heat exchange device may be in thermal contact with a single second heat exchange device. In a further example, two or more support structures 12 may each be in thermal contact with two or more separate first heat exchange devices and the separate first heat exchange devices may be in thermal contact with a single second heat exchange device.

FIG. 15 is a top view of an exemplary embodiment of the holder bench 94 incorporating multiple support structures 12 and using the temperature control techniques of the present invention. FIG. 15 again shows how the multiple support structures 12 may be arranged within the holder bench 94. This embodiment also illustrates how the inlet manifold tubes 120 and the outlet manifold tubes 100 may protrude from a side of the holder bench 94. Therefore, the inlet and outlet connectors may be embedded within the holder bench 94. Moreover, the inlet and outlet manifolds, discussed in greater detail above, may also be embedded within the holder bench 94, thereby creating a more integrated system. In particular, in the illustrated embodiment, the outlet connectors 118 are shown as being integrated into the holder bench 94. In addition, the heat exchange fluid inlet 122 and the heat exchange fluid outlet 124 may also be integrated into and protrude from the holder bench 94. The heat exchange fluid inlet and outlet 122, 124 may be used to introduce and discharge the cooling or heating fluid from the fluid circulating heat exchange elements 64.

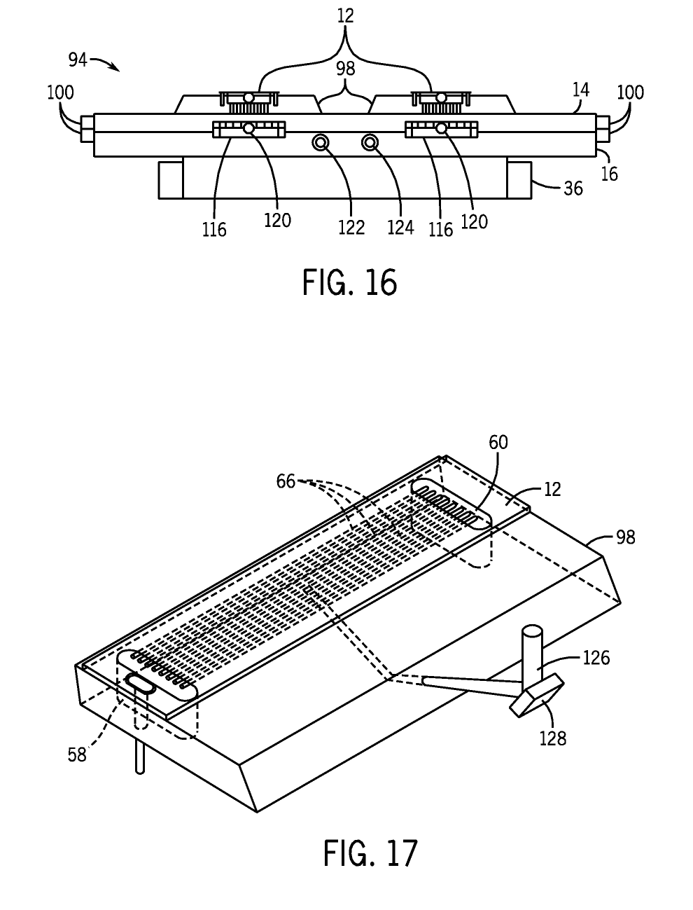

FIG. 16 is a sectional side view of an exemplary embodiment of the holder bench 94 incorporating multiple support structures 12 and using the temperature control techniques of the present invention. The multiple support structures 12 may be positioned on top of the temperature control element 14 and, optionally, directly on top of a respective prism 98 which may be used in conjunction with the TIRF-related imaging techniques, discussed below. The temperature control element 14 may be placed directly on top of the subplate 16 which, in turn, may be placed directly on top of the translation system 36. In this particular embodiment, the outlet manifold tubes 100 may actually extend from both the temperature control element 14 and the subplate 16 layers of the holder bench 94. In addition, the inlet manifold tubes 120 and associated inlet connectors 116 may also extend from both the temperature control element 14 and the subplate 16 layers of the holder bench 94. Conversely, the heat exchange fluid inlet and outlet 122, 124 have been illustrated as extending from the subplate 16 layer, which is generally where the fluid circulating heat exchange elements 64 may be expected to be located. Therefore, this embodiment illustrates that, in certain situations, there may be some overlap of components between the temperature control element 14 and subplate 16 layers of the holder bench 94. In many embodiments, the specific placement of these components may simply be for convenience or efficiency of operations.

Many of the embodiments disclosed above have illustrated epifluorescent imaging techniques wherein the excitation radiation is directed toward the surfaces of the support structure 12 from a top side, and returned fluorescent radiation is received from the same side. However, the techniques of the present invention may also be extended to alternate arrangements. For instance, these techniques may also be employed in conjunction with TIRF imaging whereby the surfaces of the support structure 12 are irradiated from a lateral or bottom side with radiation directed at an incident angle below a critical angle so as to convey the excitation radiation into the support structure 12 from a prism 98 positioned adjacent to it. Such techniques may cause fluorescent emissions from the components which are conveyed outwardly for imaging, while the reflected excitation radiation exits via a side opposite from that through which it entered. Since the excitation radiation may enter via lateral sides of the prisms 98, biological components on the multiple support structures 12 may be imaged either sequentially or simultaneously.

FIG. 17 is an isometric view of an exemplary embodiment of the support structure 12 and the prism 98 using the TIRF-related imaging techniques of the present invention. These techniques of illumination may be referred to as “top down” illumination and be useful when used in conjunction with vacuum chucking and the temperature control techniques described above. In particular, the top down illumination techniques may prove useful in that it may otherwise be problematic to illuminate from the bottom of the support structure 12 in embodiments using vacuum chucking and the temperature control techniques described above since such embodiments may utilize the space below the support structure 12. Top down or side illumination may come from above into the prism 98 upon which the support structure 12 may rest (and, optionally, be held to by vacuum). The excitation light beam 126 may be reflected off of a mirror 128 and directed toward the prism 98.

FIGS. 18A and 18B are sectional side views of an exemplary embodiment of the support structure 12 and the prism 98 using the TIRF-related imaging techniques of the present invention. As illustrated in FIG. 18A, the light beam 126 may be reflected off of the mirror 128 and may be directed toward a side 130 of the prism 98, through which the light beam 126 may pass. The light beam 126 may then proceed to reflection point 132 where the light beam 126 may reflect back toward the flow lanes 66 of the support structure 12. In particular, FIG. 18B illustrates the angles θ_{TIRF} which may be created between the light beam 126 and an axis 134 perpendicular to the surfaces of the support structure 12. In generally, this angle θ_{TIRF} may be approximately 65 degrees in order to create the most effect illumination of the support structure 12. However, this angle θ_{TIRF} may vary drastically between implementation.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system for analyzing biological samples, comprising:
a support for a biological sample;
a thermoelectric heat exchange device disposed adjacent to the support and configured to introduce heat into or extract heat from the biological sample; and
a fluid circulating heat exchange device disposed adjacent to the thermoelectric heat exchange device and configured to introduce heat into or extract heat from the thermoelectric heat exchange device.

2. The system of claim 1, wherein the support comprises a flow cell having an interior volume in which the biological sample is disposed.

3. The system of claim 2, wherein the flow cell comprises a process fluid in the interior volume and in contact with the biological sample.

4. The system of claim 2, wherein the flow cell is coupled to a process fluid inlet conduit and a process fluid outlet conduit.

5. The system of claim 1, wherein the thermoelectric heat exchange device and the fluid circulating heat exchange device are positioned at an imaging station.

6. The system of claim 5, comprising imaging optics disposed on a side of the support opposite the thermoelectric heat exchange device and configured to provide image data for the biological sample.

7. The system of claim 6, wherein the imaging optics include components configured to direct excitation radiation toward the biological sample and components to collect fluorescent radiation from the biological sample in response to the excitation radiation.

8. The system of claim 7, wherein the excitation radiation is directed toward the biological sample and components from a side of the support opposite the imaging optics using total internal reflection.

9. The system of claim 8, wherein the excitation radiation is reflected by a minor and directed through a prism.

10. The system of claim 1, wherein the support is held to the thermoelectric heat exchange device using vacuum means.

11. The system of claim 1, comprising a plurality of supports, a plurality of thermoelectric heat exchange devices, a plurality of fluid circulating heat exchange devices, or a combination thereof.

12. A method for analyzing biological samples, comprising:
providing a biological sample disposed adjacent to a support;
cooling or heating the biological sample via a thermoelectric heat exchange device disposed adjacent to the support; and
cooling or heating the thermoelectric heat exchange device via a fluid circulating heat exchange device disposed adjacent to the thermoelectric heat exchange device.

13. The method of claim 12, wherein the support comprises a flow cell having an interior volume in which the biological sample is disposed, and wherein the method includes circulating a process fluid through the interior volume.

14. The method of claim 12, wherein the thermoelectric heat exchange device and the fluid circulating heat exchange device are positioned at an imaging station, and wherein the method includes cooling the biological sample before and/or during and/or after generating image data for the biological sample.

15. The method of claim 14, comprising using imaging optics to direct excitation radiation toward the biological sample and collect fluorescent radiation from the biological sample in response to the excitation radiation.

16. The method of claim 15, comprising directing excitation radiation toward the biological sample from a side of the support opposite the imaging optics using total internal reflection.

17. The method of claim 12, comprising sensing temperature and controlling operation of the thermoelectric heat exchange device or the fluid circulating heat exchange device based upon the sensed temperature.

18. The method of claim 17, wherein the sensed temperature is a temperature of a process fluid introduced into, present in, or exiting from the support.

19. A system for analyzing biological samples, comprising:
a support for a biological sample;
a thermoelectric heat exchange device disposed adjacent to the support and configured to introduce heat into or extract heat from the biological sample;
a fluid circulating heat exchange device disposed adjacent to the thermoelectric heat exchange device; and
a subplate disposed adjacent to the fluid circulating heat exchange device;
wherein the fluid circulating heat exchange device is configured to maintain the temperature of the subplate at a substantially constant temperature.

20. The system of claim 19, wherein the fluid circulating heat exchange device is integrated into the subplate.
